(19) United States
(12) Patent Application Publication
(10) Pub. No.: US 2015/0032931 A1
(43) Pub. Date: Jan. 29, 2015

(54) Synchronous Bus Width Adaptation

(71) Applicant: Broadcom Corporation, Irvine, CA (US)

(72) Inventors: David Alan Baer, San Jose, CA (US); Brian Schoner, Fremont, CA (US); Jin-Chin Wang, Union City, CA (US)

(21) Appl. No.: 14/040,261

(22) Filed: Sep. 27, 2013

Related U.S. Application Data
(60) Provisional application No. 61/858,968, filed on Jul. 26, 2013.

(51) Int. Cl. G06F 13/40

(52) U.S. Cl. CPC G06F 13/4018
USPC 710/307

(57) ABSTRACT

A system includes a first processing component, a second processing component, and an adapted bus linking the first and second processing components. The adapted bus may account for a circuit characteristic or on-chip variation in the system. For example, the bus may be adapted to include a wider data width because of an effect of the on-chip variation that limits performance of the bus at a lower data width. The bus may include a widened data width for a portion of the bus. In that regard, the bus may include a bus expander and a bus narrower for adjusting the data width of the bus.

### CROSS REFERENCE TO RELATED APPLICATIONS

This application claims priority to provisional application Ser. No. 61/858,968, titled “Synchronous Bus Width Adaptation,” and filed Jul. 26, 2013, which is incorporated by reference in its entirety.

### TECHNICAL FIELD

This disclosure relates routing data in a system through a bus. This disclosure also relates to a bus that includes structures that expand and narrow bus width.

### BACKGROUND

With the rapid advance of technology in the past decades, complex electronic devices are in widespread use in virtually every context of day to day life. Vast communication networks support a continuous exchange of data between countless electronic devices, which may require certain levels of reliability, efficiency, power, and cost. Improvements in the ability to layout, design, and implement such electronic devices will help continue to drive the widespread adoption and demand for such electronic devices.

### BRIEF DESCRIPTION OF THE DRAWINGS

FIG. 1 shows an example of an electronic device that implements an adapted bus.

FIG. 2A shows an exemplary bus that the system logic may implement.

FIG. 2B shows an exemplary bus that the system logic may implement.

FIG. 3A shows an example implementation of a bus expander.

FIG. 3B shows an example implementation of a bus expander.

FIG. 4A shows an example implementation of a bus narrower.

FIG. 4B shows an example implementation of a bus narrower.

FIG. 5 shows a timing diagram for an exemplary bus implementation.

FIG. 6 shows a timing diagram for an exemplary bus implementation.

FIG. 7 shows an exemplary bus that the system logic may implement.

FIG. 8 shows an example of a design system.

FIG. 9 shows an example of logic that the design system may implement to determine an adapted bus.

FIG. 10 shows an example of a cost graph that the design logic may determine.

### DETAILED DESCRIPTION

The discussion below makes reference to buses. A bus may refer to any communication link for transferring data in a system. For example, a bus may refer to internal connections within a processing component of a system, such as a communication path between elements of a microprocessor or memory, for example. The bus may refer to connections linking processing components in the system, such as a system bus linking the microprocessor to the memory. A bus may be characterized by any data width, whether 1-bit wide or thousands of bits wide.

A bus or a portion of the bus may be subject to one or more timing constraints. For example, timing closure requirements in a system may require that a destination receive data sent through a bus within a specified number of clock cycles. Accordingly, timing closure constraints are governed by the clock speed driving the bus or a system implementing the bus. For example, the system may require single cycle timing closure where data sent from a source is received by a destination within a single clock cycle. Thus, as clock speeds increase, the “effective distance” through which a bus routes data also increases.

The methods, systems, and techniques described below may support efficient and flexible implementation of buses. In particular, the systems and techniques below may support implementation of buses flexibly adapted according to various factors, including cost, power consumption, chip layout, routing constraints, effect of on chip variations, and timing constraints. A system may include multiple adapted buses with differing and specific bus designs based on chip layout or other parameters.

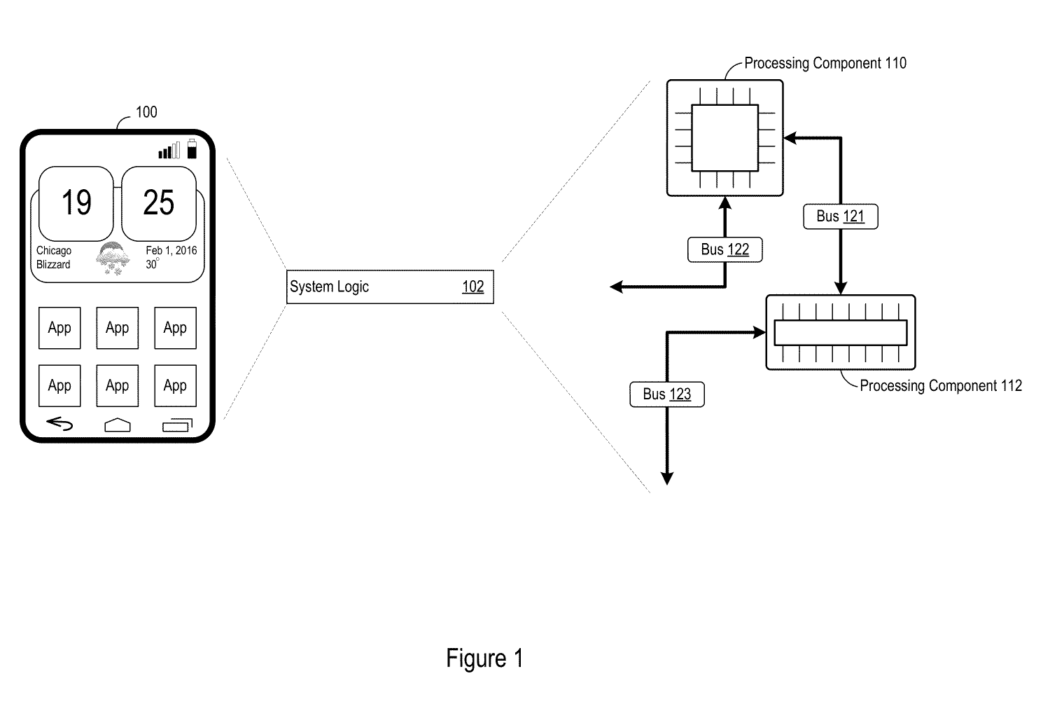

FIG. 1 shows an example of an electronic device 100 that implements an adapted bus. The electronic device 100 may be any device that includes logic or circuitry for processing data. In FIG. 1, the exemplary electronic device 100 is a cellular phone, but the electronic device 100 may alternatively take the form of a laptop, desktop, or other type of computer, a personal data assistant, or a portable email device. Additional examples of electronic devices 100 include routers, gateway devices, network switches, hubs, servers, televisions, stereo equipment such as amplifiers, pre-amplifiers, and tuners, home media devices such as a set top boxes, compact disc (CD)/digital versatile disc (DVD) players, portable MP3 players, high definition (e.g., Blu-Ray (™) or DVD audio) media players, or home media servers. Other examples of electronic devices 100 include vehicles such as cars and planes, societal infrastructure such as power plants, traffic monitoring and control systems, or radio and television broadcasting systems. Further examples include home climate control systems, washing machines, refrigerators and freezers, dishwashers, intrusion alarms, audio/video surveillance or security equipment, network attached storage, and network routers and gateways. The electronic devices 100 may be found in virtually any context, including the home, business, public spaces, or automobile. Thus, as additional examples, the electronic devices 100 may further include automobile engine controllers, audio head ends, satellite music transceivers, noise cancellation systems, voice recognition systems, climate control systems, navigation systems, alarm systems, or other devices.

The electronic device 100 includes system logic 102. The system logic 102 may include any combination of hardware, software, firmware, or other logic. The system logic 102 may be implemented, for example, in a system on a chip (SoC), application specific integrated circuit (ASIC), or other circuitry and the system logic 102 may include one or more integrated circuits (ICs), controllers, microprocessors, or other logic components. The system logic 102 is part of the implementation of any desired functionality in the electronic device 100, such as receiving, processing, and routing data, executing applications, saving and retrieving application data, and more.

In FIG. 1, the system logic 102 includes processing components, such as the processing components labeled as 110 and 112. The processing components 110 and 112 may implement any processing component of the system logic 102 as any combination of hardware, software, or firmware. The processing components 110 and 112 may include synchronous logic, asynchronous logic, or a combination of both. As one example, the logic elements 110 or 112 may include a processor or an element of a processor, such as a controller, arithmetic logic unit (ALU), decoding unit, an input/output (I/O) interface or other communication interface, and more. The logic elements 110 or 112 may include memory or memory logic, such as a register array, L2 or L3 cache, instruction register, random access memory (RAM), memory controllers, and the like. As additional examples, the logic elements may include discrete logic such as flip-flops, shift registers, and combinatorial logic, whether present in discrete packages or inside one or more Programmable Logic Device (PLD) packages.

The system logic 102 includes buses that link processing components. In the example shown in FIG. 1, a bus 121 communicatively links processing component 110 to processing component 112 through which the processing components 110 and 112 may communicate data. The system logic 102 in FIG. 1 also includes the buses labeled as 122 and 123, through which the processing components 110 and 112 may respectively communicate with other components of the system logic 102.

The system logic 102 may implement an adapted bus in the system logic 102. As described in greater detail below, the bus 121 may be an adapted bus implemented according to one or more adaptation parameters. The adaptation parameters may include on-chip variations at or near a position where the bus 121 is implemented, cost or power requirements, routing constraints, distance between linked components, latency or other communication requirements of one or more processing components connected to the bus 121, and more. Accordingly, the configuration of the bus 121, such as bus width, timing constraints, implementation, routed path, and elements included in the bus 121 may be determined according to the adaptation parameters. In a similar regard, the system logic 102 may also implement buses 122 and 123 as adapted buses based on the adaptation parameters. For example, the buses 121, 122, and 123 may differ in bus width, route, speed, power consumption, latency, and configuration as the system logic 102 flexibly implements the buses 121, 122, and 123 according to different respective implementation constraints or requirements associated with the buses 121, 122, and 123.

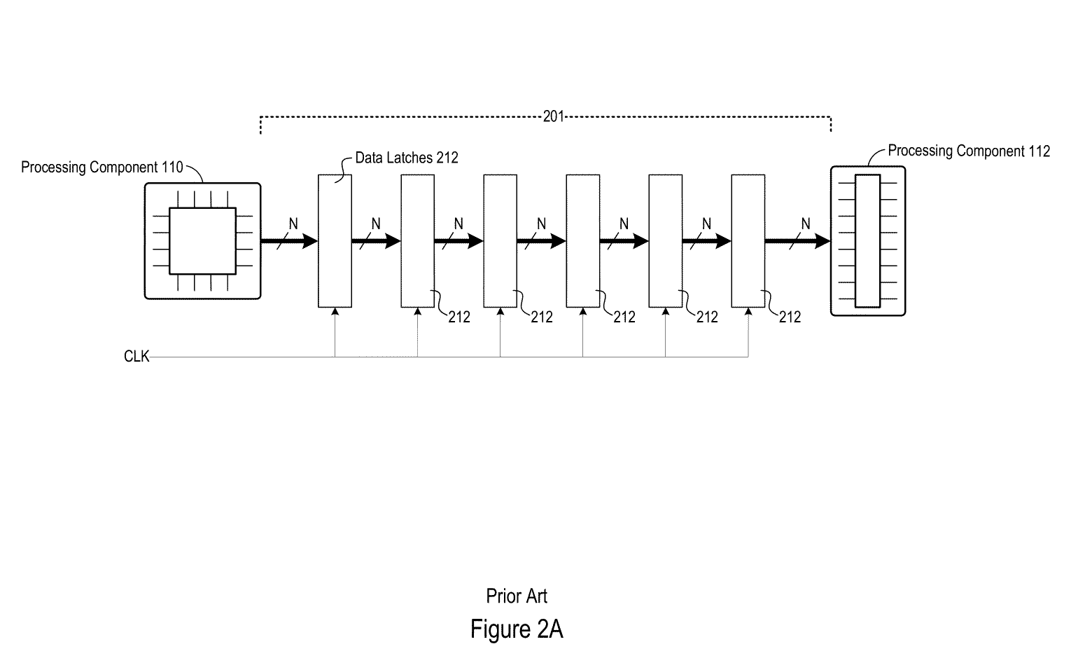

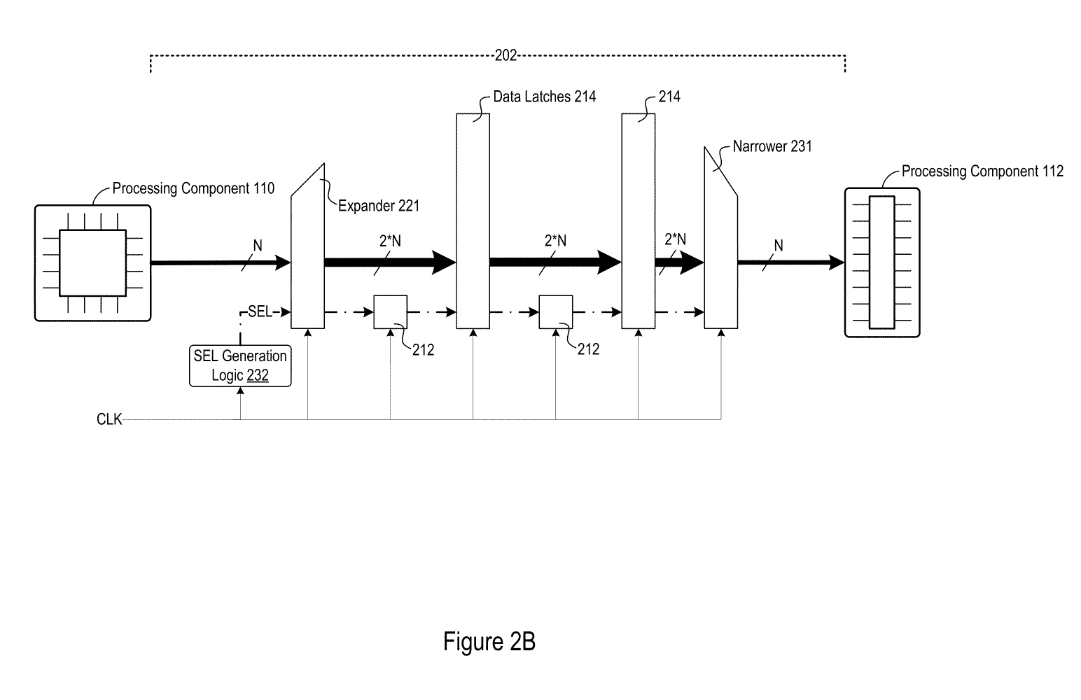

FIG. 2A shows an exemplary bus 201 that the system logic 102 may implement. In FIG. 2A, the bus 201 implements a communication path for data sent from the processing component 110 and received by the processing component 112. Also as seen in FIG. 2A, the processing component 110 outputs data ‘N’ bits at a time (e.g., in parallel) and the processing component 112 receives data ‘N’ bits at a time.

The exemplary bus 201 includes wiring and bus pipeline stages that route data at a constant bus width. In particular, the bus 201 in FIG. 2A routes data sent from processing component 110 to processing component 112 at a constant bus width of ‘N’ bits. The bus 201 shown in FIG. 2A includes six bus pipeline stages, each stage implemented as a set of data latches 212. A bus pipeline stage may receive, store, and send data communicated through the bus. The number of pipeline stages may vary based on timing closure constraints and wire delays, and the system logic 102 may implement the bus pipeline stages to meet single cycle timing closure. Put another way, the positioning of the data latches 214 in the system logic 102 may ensure the propagation of data to a subsequent pipeline stage in the bus in the span of a single clock cycle. For example, the system logic 102 may implement the data latches 212 at particular physical positions on a chip or space the data latches 212 apart at a particular distance interval to ensure that, given the wire delay for communicating data between the data latches 212, the propagated data can reach a next pipeline stage in a single clock cycle.

The data latches 212 may include a set of flip-flops that latch data every clock cycle. For example, the data latches 212 may latch input data to the data latches 212 at each rising edge of a clock signal, such as the clock signal CLK supplied to the bus 201. The data latches 212 may then output the latched data, thereby propagating data received from a previous bus pipeline stage to a subsequent bus pipeline stage.

The bus 201 has an associated latency related to the number of implemented pipeline stages in the bus 201. For example, in FIG. 2A, the bus 201 includes six bus pipeline stages, which adds a latency of six clock cycles for sending data from the processing component 110 to the processing component 112. In this example, the latency of the bus 201 shown in FIG. 2A has a latency of seven clock cycles, e.g., seven clock cycles elapse from when the processing component 110 sends data to when the processing component 112 receives the data. The bus 201 may include a number of bus pipeline stages to meet single cycle timing closure for data as it is being communicated through the bus 201.

FIG. 2B shows an exemplary bus 201 that the system logic 102 may implement. In FIG. 2B, the bus 202 implements a communication path for data sent from the processing component 110 and received by the processing component 112. The bus 202 may additionally or alternatively implement a communication path in the reverse direction or a bi-directional communication path between the components 110 and 112. The bus 202 routes data from processing component 110 to processing component 112. The exemplary bus 202 includes a bus expander 221 and a bus narrower 231. The bus expander 221 and narrower 231 may adjust the data width of a bus allowing the bus 202 to communicate data at a widened or narrowed bus width. Specifically, in the bus 202 shown in FIG. 2B, the expander 221 receives ‘N’ bits of data from the processing component 110 and outputs ‘2*N’ bits of data. The narrower 231 receives ‘2*N’ bits of data and outputs ‘N’ bits of data to the processing component 112. In this respect, the bus expander 221 performs a data deserialization role, in this instance converting 2 sets of N-wide data to a 2N wide data unit. Similarly, the bus narrower 231 performs a data serialization role, in this instance converting 2N data in parallel to 2 instances of N-wide data for the processing component 112.

Note that the bus 202 includes a smaller number of pipeline stages for routing the data from processing component 110 to processing component 112 than the bus 201 shown in FIG. 2A. The expander 221 may widen the data width of a bus to send an integer multiple amount (e.g., 2*N bits) across a portion of the bus 202. The system logic 102 may position a subsequent pipeline stage for the bus 202 such that the widened data arrives at the subsequent pipeline stage within two clock cycles instead of one. In that regard, the bus 202 may lessen the single cycle timing closure requirement for some of the pipeline stages in the bus 202, requiring two-cycle timing closure for portions of the bus 202. The bus 202 may propagate data at a same throughput rate as the bus 201, e.g., N bits every clock cycle for the bus 201 and 2*N bits every 2 clock cycles for the bus 202.

The bus 202 includes bus pipeline stages implemented as data latches 214. The data latches 214 may include a set of flip-flops (e.g., D flip-flops) that latch data according to a clock signal and an enable signal. For example, the data latches 214 may latch data at the input of the data latches 214 when an enable signal is high at the rising edge of a clock signal. The bus implementation 202 includes a selector signal SEL that serves as an enable signal for the data latches 214. In particular, the bus 202 may include selector generation logic 232 that generates the selector signal SEL. The selector generation logic 232 may generate the selector signal SEL such that the data latches 214 latch data every other clock cycle. In some variations, the selector generation logic 232 generates the selector signal SEL as a one bit signal, for example when the expander 221 doubles the width of the bus. In other variations, the selector generation logic 232 generates the selector signal SEL as a multi-bit signal, such as when the expander 221 widens the bus by more than twice the width of the incoming data received by the expander 221.

The bus 202 may route the selector signal SEL such that the selector signal SEL meets timing closure for a single clock cycle. In that regard, the bus 202 may include a selector bus pipeline that meets single cycle timing closure for routing the selector signal SEL. Accordingly, the bus 202 may include selector pipeline stages implemented as data latches 212 that latch the selector signal SEL each clock cycle. In the bus 202 shown in FIG. 2B, the expander 221, data latches 214, and/or narrower 231 may additionally or alternatively latch the selector signal SEL at each clock cycle as it is propagated through the bus 202.

The bus 202 may include a number of pipeline stages, e.g., data latches 214, to meet a specified timing latency. In some variations, the expander 221 and/or narrower 231 may affect the latency of the bus 202. Accordingly, the system logic 102 may implement a number of pipeline stages to account for the latency of the expander 221 and/or narrower 231. As one particular example, the system logic 102 may implement the bus 202 instead of the bus 201. The system logic 102 may implement the bus 202 to have the same latency of the latency associated with the bus 201. In FIG. 2A, the bus 201 has latency of 7 clock cycles, and the system logic 102 may implement the bus 202 to have a latency of 7 clock cycles as well. When the expander 221 and/or narrower 231 incur more than one cycle of latency, the system logic 102 may forego including one or more bus pipeline stages to meet the latency requirement, e.g., forego including one or more sets of data latches 214.

The bus 202 may support widening and narrowing of a bus width without a change in clock rate. For example, the expander 221 and narrower 231 may operate on the same clock tree. Put another way, the elements of the bus 202 may receive the same clock signal CLK. Accordingly, the bus 202 may widen and narrow a bus width without requiring synchronization between multiple clock trees or adjusting a clock rate. Accordingly, the bus 202 may support data width adjustments in portions of the bus 202 without incurring large latency delays or significant additional costs.

Various trade-offs exist between implementing the bus 201 as opposed to the bus 202. By implementing the bus 202 to link processing components, the system logic 102 may consume less power than by implementing the bus 201. For example, the expander 221 and/or data latches 214 of the bus 202 may consume less power to transmit widened data to a subsequent bus pipeline stage within 2 clock cycles as compared to the power consumption required for the data latches 212 of the bus 201 to propagate non-widened data to a subsequent stage in one clock cycle. The bus 202 also includes fewer pipeline stages than the bus 201 for routing the data sent from the processing component 110, which may increase the routing flexibility of the bus 202. Additionally, the bus 202 supports for positioning of bus elements at a greater physical distance between the bus pipeline stages, as the two cycle timing closure requirement allows greater freedom in positioning the elements of the bus 202 on a physical chip or IC as compared to the one cycle timing closure requirement of the bus 201.

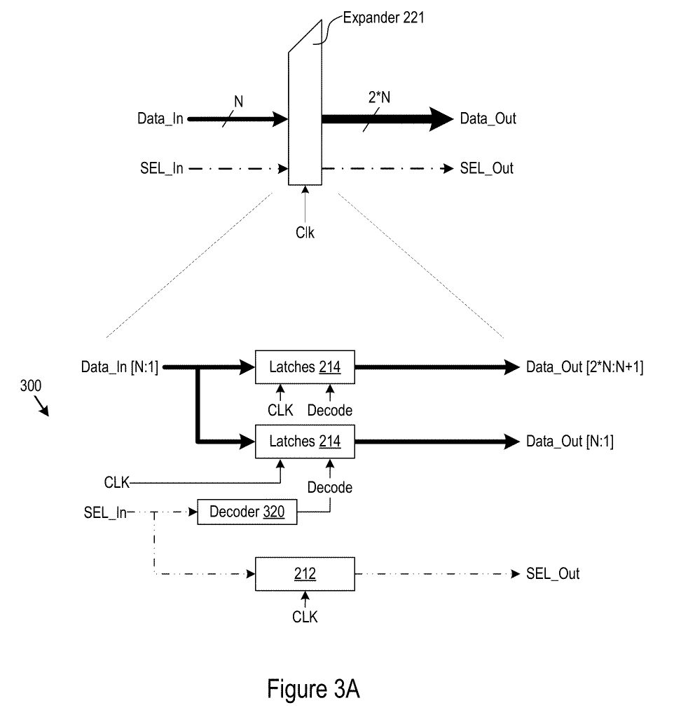

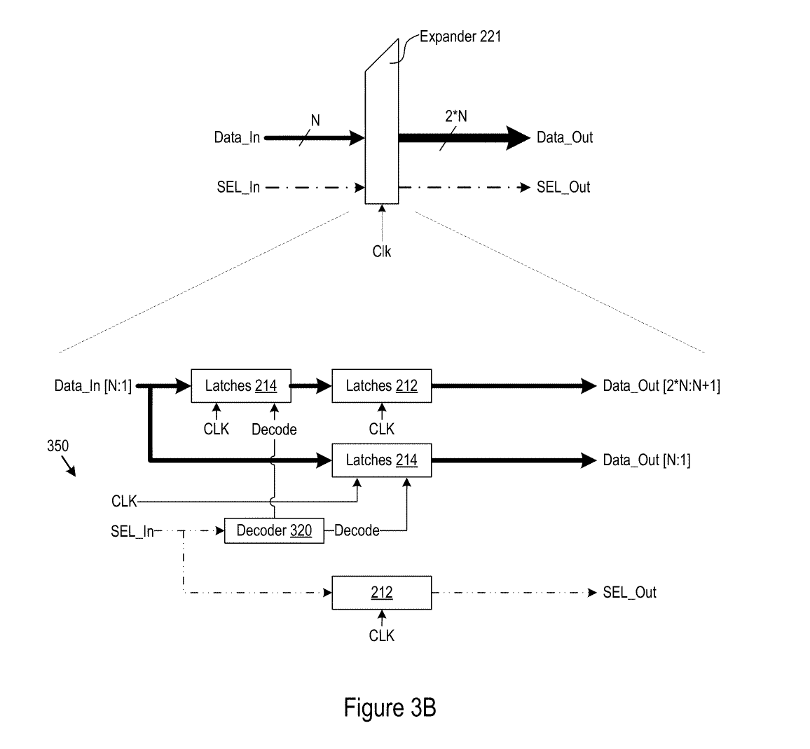

FIG. 3A shows an example implementation 300 of a bus expander 221. In FIG. 3A, the bus expander 221 widens the data width of a bus by a factor of two. The expander 221 receives ‘N’ bits of input data through a Data_In signal and outputs ‘2*N’ bits of output data through a Data_Out signal. In other variations, the expander 221 widens the data width of a bus by any multiple, e.g., by 3 times, 4 times or 8 times the data width of the input data.

The bus expander 221 may include memory banks for storing and outputting data. The bus expander 221 shown in FIG. 3 includes memory banks in the form of two sets of latches 214, e.g., an upper set and lower set of latches 214. The upper set of latches 214 may output ‘N’ bits of data as the upper range of the Data_Out signal, e.g., bits N+1 to 2*N of the Data_Out. The lower set of latches 214 may output ‘N’ bits of data as the lower range of the Data_Out signal, e.g., bits 1 to N of the Data_Out.

The expander 221 may receive a Data_In signal and send the ‘N’ bits of Data_In to both the upper and lower sets of latches 214. The two sets of latches 214 may alternate in latching the Data_In signal. In that regard, the bus expander 221 may include a decoder 320, e.g., a counter that repeatedly counts to N−1 and returns to 0. The decoder 320 may receive the selector signal SEL_In and select one of the sets of latches 214 for latching the Data_In based on the SEL_In signal. In one implementation where the selector signal SEL is implemented as single bit signal, the decoder 320 may generate a decode signal such that a first set of latches 214 latches the Data_In data when the SEL signal is low and a second set of latches 214 latches the Data_In data when the SEL signal is high. For example, decoder 214 may send a respective 1-bit decode signal to the upper and lower sets of latches 214 indicating which of the sets of latches 214 should latch the Data_In signal (e.g., by a decode high signal to the upper set of latches 214 and a low decode signal to the lower set of latches 214). The upper and lower sets of latches 214 may interpret the respective decode signals from the decoder 320 as a load enable signal, for example.

The expander 221 may propagate the selector signal SEL to a subsequent selector pipeline stage. In FIG. 3, the expander receives an input selector signal labeled as SEL_In and latches the SEL_In signal in the latch labeled as 212. The latch 212 may sample the SEL_In signal each clock cycle and send the sampled SEL_In as the SEL_Out signal.

FIG. 3B shows another example implementation 350 of a bus expander 221. The exemplary bus expander 221 shown in FIG. 3B widens the data width of a bus by a factor of two. The expander 221 may receive, in parallel, ‘N’ bits of input data through the Data_In signal and output, in parallel, ‘2*N’ bits of output data through the Data_Out signal.

In the exemplary implementation 350 shown in FIG. 3B, the bus expander 221 includes multiple memory banks, including an upper memory bank that includes a set of latches 214 and a set of latches 212 and a lower memory bank that includes a set of latches 214. The sets of latches 214 in the upper and lower memory banks may each receive a decode signal from the decoder 320, and the bus expander 221 may alternate in latching the Data_In signal, e.g., as similarly described in the implementation 300 of a bus expander 221 shown in FIG. 3A.

The exemplary implementation 350 may allow the bus expander 221 to hold data in the upper set of latches 212 to synchronize the sending 2*N bits of data across the Data_Out signal to a next pipeline stage. For example, when the Data_In signal has an input stream of 0x00, 0x11, 0x22, and 0x33 in a span of four clock cycles, the implementation 350 of the bus expander 221 may latch the 0x00 and 0x22 Data_In values for an extra cycle in the upper set of latches 212. Thus, the expander 221 may output a coordinated Data_Out signal of 0x - - -, 0x - - - , 0x0011, 0x0011, 0x2233, 0x2233 in a span of size clock cycles.

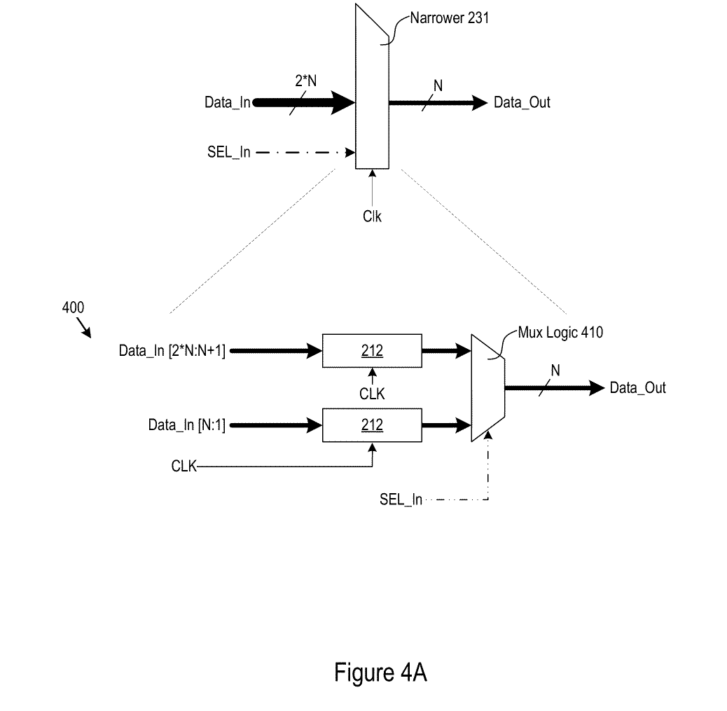

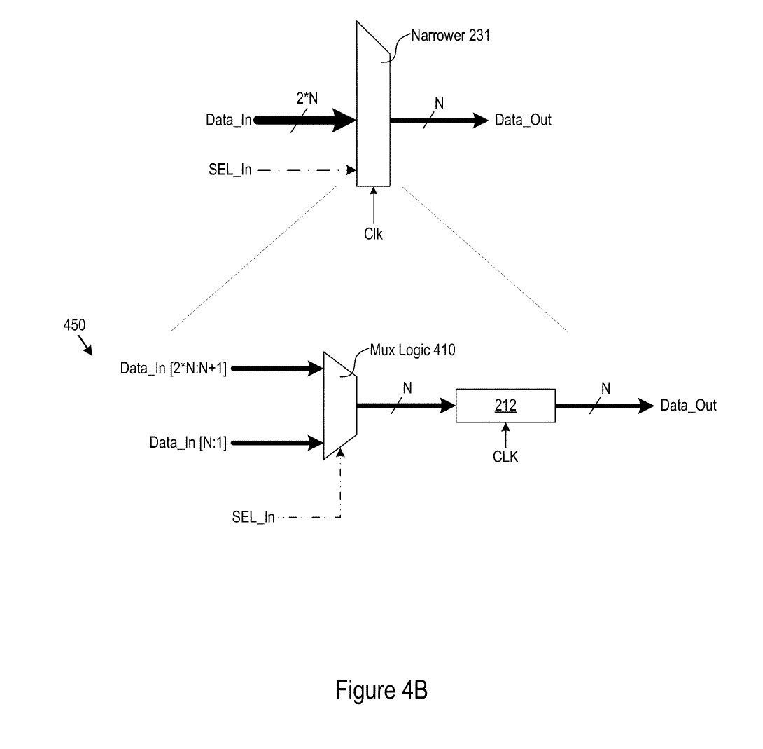

FIG. 4A shows an example implementation 400 of a bus narrower 231. In FIG. 4, the bus narrower 231 narrows the data width of a bus by a factor of two. The narrower 231 receives ‘2*N’ bits of input data through a Data_In signal and outputs ‘N’ bits of output data through a Data_Out signal. In other variations, the narrower 231 narrows the data width of a bus by any multiple, e.g., by 3 times, 4 times or 8 times the data width of the input data. The narrower 231 may narrow the data width of a bus at a different factor that the expander 221. For example, a bus that includes an expander 221 and a narrower 231 may receive data from source at a data width of ‘N’ bits and deliver data to a destination at a data width of ‘2*N’ bits. In this example, the expander 221 may, for example, widen the data width of the bus to ‘4*N’ bits and the narrower 231 may narrow the received data to a data width of ‘2*N’ bits.

The bus narrower 231 may include memory banks for storing input data. The bus narrower 231 shown in FIG. 4 includes two sets of latches 212, e.g., an upper set and lower set of latches 212. The upper set of latches 212 may receive the upper ‘N’ bits of data from the Data_In signal, e.g., bits N+1 to 2*N of the Data_In signal. The lower set of latches 214 may receive the lower ‘N’ bits of the Data_In signal, e.g., bits 1 to N of the Data_In signal. In some variations, the upper and lower sets of latches 212 in the narrower 231 latch the input data each clock cycle. In other variations, the narrower 231 may include latches 214 that latch input data based on a load enable and clock signal. In this variation, the narrower may include decoding logic that receives a selector signal SEL_In and determines one of the memory banks to instruct to latch the incoming data.

The bus narrower 231 may narrow the input data through multiplexer (mux) logic 410. In that regard, the mux logic 410 may receive the selector signal SEL_In and determine one of the sets of latches 212 from which to output data as the Data_Out signal.

FIG. 4B shows another example implementation 450 of a bus narrower 231. In the exemplary implementation 450, the system logic 102 may implement the bus narrower 231 to include a set of latches 212 and mux logic 410. The mux logic 410 may receive the Data_In signal and select between bits ‘N+1’ to ‘2*N’ and bits 1 to ‘N’ of the Data_In signal, e.g., using the SEL_In signal. The set of latches 212 may sample the output of the mux logic 410 according to a clock signal CLK and output the Data_Out signal.

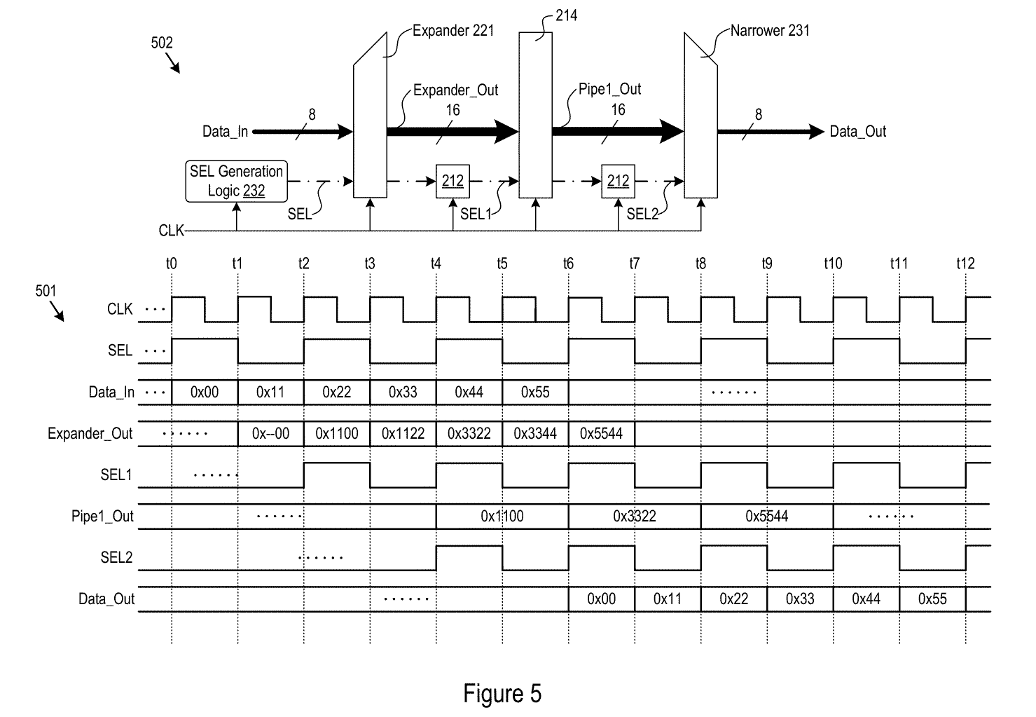

FIG. 5 shows an example of a timing diagram 501 for an exemplary bus 502. The system logic 102 may implement the bus 502 as an alternative to implementing the bus 201, for example. The exemplary bus 502 includes three bus pipeline stages for routing a Data_In signal received from a source, including a first stage implemented by the expander 221, a second stage implemented by the latches 214, and a third stage implemented by the narrower 231. The system logic 102 may implement the bus expander 221 according to the exemplary implementation 300 shown in FIG. 3A and the bus narrower 231 according to the exemplary implementation 400 shown in FIG. 4A, for example.

The various elements of the bus 502 may be physically positioned to meet various timing closure requirements. The expander 221 may be positioned to meet one cycle timing closure for data received from a source component and the narrower 231 may be positioned to meet one cycle timing closure for data sent to a destination component. The latches 214 may be positioned to meet two cycle timing closure for data received from the expander 221 and for data sent to the narrower 231. In the example shown in FIG. 5, the Data_In and Data_Out signals are 8 bits in width. The expander 221 widens the data width of a portion of the bus 502 to 16 bits and the narrower 231 narrows the data width of the bus 502 back to 8 bits.

Turning to the timing diagram 501, at a time t0, a source processing component in the system logic 102 may send a Data_In signal to the bus 502 that has a value of 0x00. The source processing component may send subsequent data as well, such as the data 0x11 at time t1, data 0x22 at time t2, and so on. The expander 221 receives the data with value 0x00 at time t1, and outputs the 0x00 data as a lower portion of the 16 bit output of the expander 221 labeled in FIG. 5 as the Expander_Out signal. As seen through the Expander_Out signal, the expander 221 may alternate latching data in upper and lower memory banks that are 8 bits wide. For example, the expander 221 may determine a particular memory bank to latch the 8-bit input data based on the selector signal SEL generated by the selector generation logic 232.

At time t2, the expander 221 outputs an Expander_Out signal with a value of 0x1100. In the exemplary bus 502, the bus pipeline stage subsequent to the expander 221 is implemented by the latches 214. The bus 502 propagates the selector signal SEL generated by the selector generation logic 232, and the latches 214 receive the selector signal SEL two cycles after generation by the logic 231, as indicated through the selector signal labeled as SEL1. The latches 214 may sample data received from the expander 221 at a rate of every two clock cycles based on the received selector signal SEL1. In particular, the latches 214 may latch data when the SEL1 signal is high during a rising clock edge. Accordingly, at a time t4 that is two cycles after the expander 221 outputs a value of 0x1100 through the Expander_Out signal, the latches 214 latch and output the 0x1100 value. Two cycles later at time t6, the latches 214 latch and output a value of 0x3322 and at time t8, the latches 214 latch and output the value of 0x5544. The latches 214 output 16-bits of data labeled as the Pipe1_Out signal in FIG. 5.

The narrower 231 may receive 16-bit output from the latches 214 within two clock cycles. Accordingly, at time t6, the narrower 231 receives the 0x1100 value output from the latches 214 on the Pipe1_Out signal at time t4. The narrower 231 may narrow the received 16-bit data and output 8-bits of data through the Data_Out signal. The narrower 231 may output the data to the Data_Out signal in the same order that the data was received by the bus 502 through the Data_In signal. For example, mux logic 410 in the narrower 231 may determine an output order for the output data based on the selector signal received by the narrower 231 and labeled as SEL2.

In the example shown in FIG. 5, the bus 502 has a latency of seven clock cycles. That is, data sent from the source processing component through the bus 502 may arrive at the destination processing component seven clock cycles later.

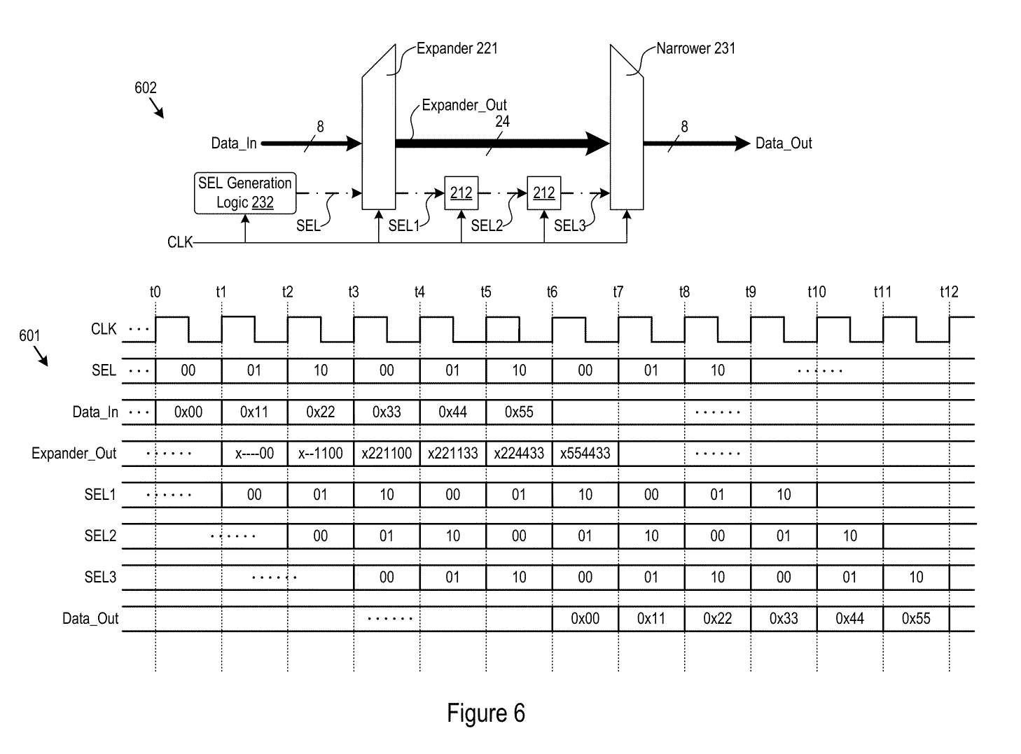

FIG. 6 shows an example of a timing diagram 601 for an exemplary bus 602. The exemplary bus 602 shown in FIG. 6 also has a latency of seven clock cycles. The system logic 102 may implement the bus 602 as an alternative to implementing the buses 201 or 502, for example. The exemplary bus 602 includes two bus pipeline stages for routing a Data_In signal received from a source, including a first bus pipeline stage implemented by the expander 221 and a second stage implemented by the narrower 231. The system logic 102 may implement the bus expander 221 according to the exemplary implementation 300 shown in FIG. 3A and the bus narrower 231 according to the exemplary implementation 400 shown in FIG. 4A, for example.

The various elements of the bus 602 may be physically positioned to meet various timing closure requirements. The expander 221 may be positioned to meet one cycle timing closure for data received from a source processing component and the narrower 231 may be positioned to meet one cycle timing closure for data sent to a destination processing component. The expander 221 and narrower 231 in FIG. 6 may be physically positioned on a chip or IC to meet three cycle timing closure for data sent from the expander 221 to the narrower 231. In the example shown in FIG. 6, the Data_In and Data_Out signals are 8 bits in width. The expander 221 widens the data width for a portion of the bus 602 to 24 bits and the narrower 231 narrows the data width of the bus 602 back to 8 bits. In that regard, the expander 221 and narrower 231 may each include three memory banks respectively corresponding to bits [1:8], [9:16], and [17:24] of the 24-bit data signal sent from the expander 221 to the narrower 231, which is labeled in FIG. 6 as the Expander_Out signal.

The timing diagram 501 illustrates operation of the bus 602 at various times before, during, and after the bus 602 receives data through the Data_In signal. Of note, the selector generation logic 232 generates the selector signal SEL as a 2-bit value that cycles between the values ‘00’, ‘01’, and ‘10’. The expander 221 widens received data to 24 bits and may select one of the three 8-bit memory banks in the expander 221 to latch and output the Data_In signal. For example, the expander 221 may include a decoder 320 that selects one of the three memory banks based on the value of a received selector signal SEL.

The bus 602 may propagate the selector signal SEL to meet a one cycle timing closure requirement. The narrower 231 may receive a propagated selector signal SEL, labeled as signal SEL3 in FIG. 6. The narrower 231 may output data to the Data_Out signal in the same order that the data was received by the bus 602 through the Data_In signal, for example by using the received SEL3 signal to determine which 8-bits of the Expander_Out signal to output through the Data_Out signal. The narrower 231 may include mux logic 410 that determines an output order for the output data based on the selector signal SEL3.

As seen in the timing diagram 601, the bus 602 receives data through the Data_In signal and outputs the data six clock cycles later through the Data_Out signal. Thus, a destination component may receive the data through the Data_Out signal at a seventh cycle.

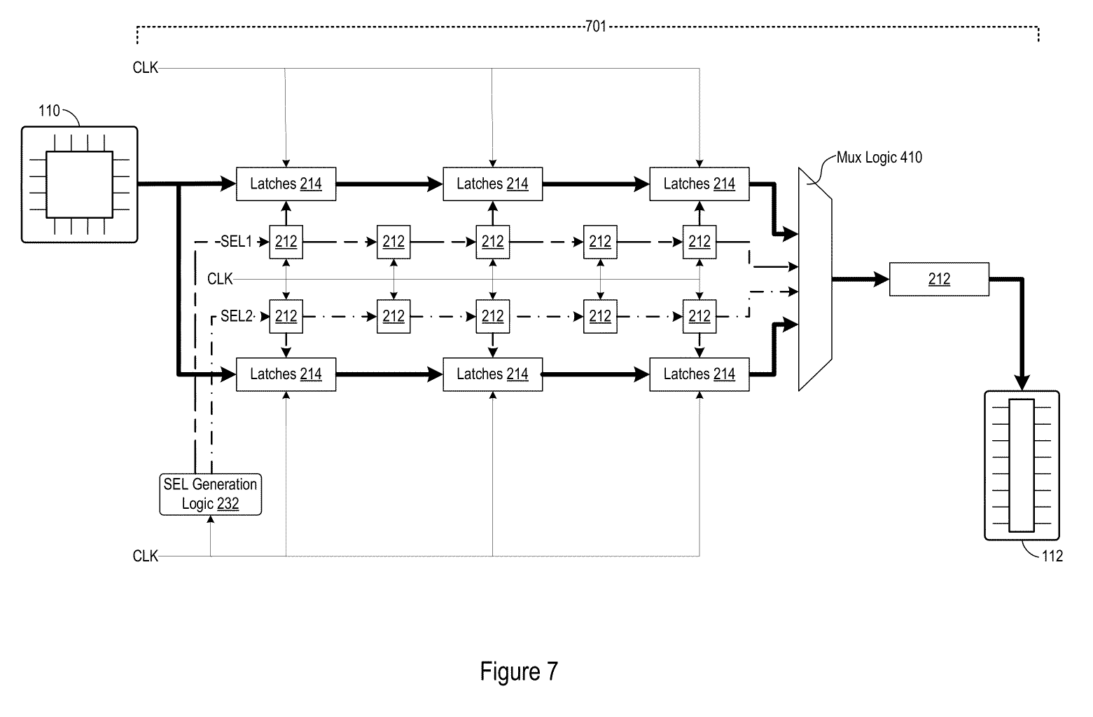

FIG. 7 shows an example of an exemplary bus 701 that the system logic 102 may implement. The system logic 102 may implement the bus 701 instead of the bus 201, for example, and preserve the seven clock cycle timing latency of the bus 201. That is, the system logic 102 may implement the bus 701 such that seven clock cycles elapse from when the processing component 110 sends data to when the processing component 112 receives the data. As seen in FIG. 7, the bus 701 widens the data output from the processing component 110 to realize many of the timing relaxation and power saving benefits described above, e.g., with respect to the bus 202. Additionally, the system logic 102 may implement the bus 701 without adding any latency in communicating data between the processing components 110 and 112 when compared to the bus 201.

In the exemplary bus 701 shown in FIG. 7, the selector generation logic 232 generates multiple selector signals, including the selector signals labeled as SEL1 and SEL2 respectively. The bus 701 may route the selector signals SEL1 and SEL2 to meet timing closure for a single clock cycle. As seen in FIG. 7, the bus 701 propagates the SEL1 signal through an upper set of latches 212 and the SEL2 signal through a lower set of latches 212. SEL1 is selectively input to an upper set of latches 214 that receive and propagate data from the processing component 110. Similarly, SEL2 is selectively input to a lower set of latches 214 that receive and propagate data from the processing component 110.

The upper set of latches 214 and lower set of latches 214 may alternate in latching data output from the processing component 110, as controlled by the selector signals SEL1 and SEL2. For example, when the processing component 110 outputs 8 bits of data in parallel, the processing component may output the data 0x00 at a first clock cycle and 0x11 at a second clock cycle. The SEL1 signal may cause a first latch 214 of the upper set of latches 214 to sample the 0x00 output data but not the 0x11 output data from the processing component 110. The SEL2 signal may cause a first latch 214 of the lower set of latches 214 to not sample the 0x00 output data and sample the 0x11 output data from the processing component 110. In other variations of the bus 701, the selector generator logic 232 may output a single SEL signal and the upper set of latches 214 may respond to the SEL signal in an alternate fashion from the lower set of latches 214, e.g., the upper set of latches 214 may sample data when the SEL signal is high and not sample data when the SEL signal is low whereas the lower set of latches 214 may not sample data when the SEL signal is high and sample data when the SEL signal is low (or vice versa).

The bus 701 may include mux logic 410. The mux logic 410 may receive data propagated through the upper and lower set of latches 214 as well as the SEL1 signal, the SEL2 signal, or both. The mux logic 410 may select between outputting data from the upper or lower set of latches 214 based on the selector signals SEL1 and/or SEL2. In that regard, the mux logic 410 may narrow the data of the bus 701 and output data for sampling in a data latch 212 in a consistent order as the data was output from the processing component 110 unto the bus 701.

The buses 201, 202, 502, 602, and 701 described above may represent various design options for a bus implemented by the system logic 102. The system logic 102 may implement a bus according to any combination elements and configurations from buses 201, 202, 502, 602, or various other bus designs. For example, a bus implemented by the system logic 102 may include a first portion with a fixed data width (e.g., similar to bus 201) and a second portion with a widened data width to account for an effect of an on-chip variation in the system logic 102 at or within a predetermined distance from the second (e.g., widened) portion of the bus.

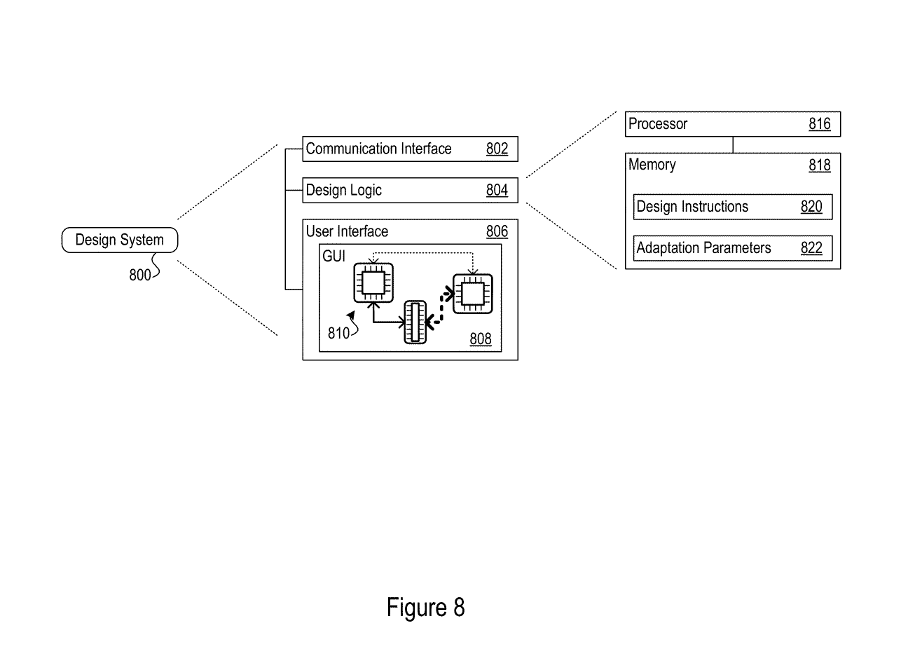

FIG. 8 shows an example of a design system 800. The design system 800 may determine a bus implementation for one or more buses in the system logic 102. In that regard, the design system 800 may determine an adapted bus design for implementing a particular bus in the system logic 102.

The design system 800 may include a communication interface 802, design logic 804, and user interface 806. The design logic 804 is part of the implementation of any desired functionality in the design system 800, including the creation, modification, analysis, or optimization of design of the system logic 102 of an electronic device 100. For example, the design logic 804 may include computer aided design (CAD) tools used for chip design, including bus layout.

The user interface 806 may display, for example, a graphical user interface (GUI) 708 that displays a design interface 810. The user interface 806 may accept bus configuration requirements, parameters, or criteria for adapting one or more buses in designing the system logic 102. The design interface 810 may visualize processing elements of a chip or IC implementing the system logic 102 and bus design options, criteria and configurations, as just a few examples.

The design logic 804 may be implemented in hardware, software, or both. In one implementation, the design logic 804 includes one or more processors 816 and memories 818. The memory 818 may store design instructions 820 (e.g., program instructions) for execution by the processor 816. The memory 818 may also store adaptation parameters 822. The adaptation parameters 822 may specify any requirements, configurations, constraints, costs, parameters, or any other criteria associated with determining a bus implementation for one or more buses of the system logic 102. The adaptation parameters 822 may be preconfigured, configured through user input, or otherwise adjusted in any number of ways.

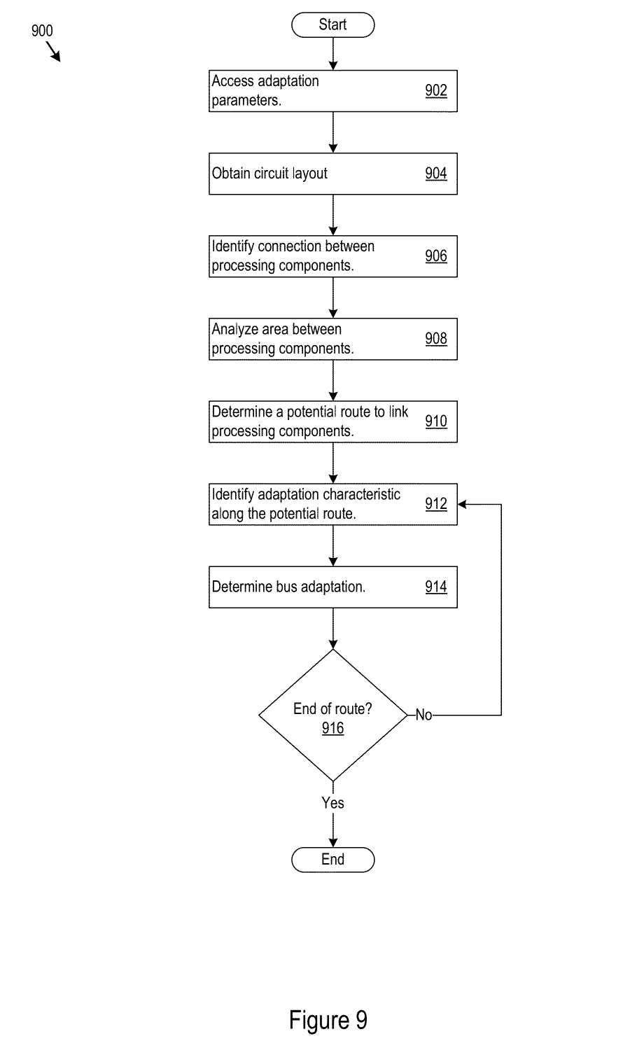

FIG. 9 shows an example of logic 900 that the design logic 804 may implement to determine an adapted bus. The design logic 804 may implement the logic 900 as any combination of hardware, software, or firmware. For example, the design logic 804 may implement the logic 900 in software as the design instructions 820.

The design logic 804 may access the adaptation parameters 822 (902) and obtain a circuit layout (904). The circuit layout may include one or more processing components and the design logic 804 may identify a connection between a first and second processing component in the circuit layout (906). In some variations, the circuit layout may already include a bus linking a first and second processing component, and the design logic 804 may identify the bus as the connection. As such, the design logic 804 may adapt the bus according to one or more of the adaptation parameters 822. In other variations, the circuit layout may not include a bus linking the first and second processing components, and the design logic 804 may identify the connection as an area between the first and second processing components for determining an adapted bus.

The design logic 804 may analyze the area between the first and second processing components (908) and determine one or more potential routes for linking the first and second processing components (910), e.g., one or more potential routes for an adapted bus. For a potential route, the design logic 804 may determine the presence of an adaptation characteristic along the potential route (912). Examples of adaptation characteristics are presented below. Upon identifying an adaptation characteristic along the potential route, the design logic 804 may determine a bus adaptation, such as widening or narrowing the bus width of the bus. The design logic 804 may continue to identify adaptation characteristics and determine bus adaptions until the route between the processing components ends (916).

In some implementations, the design logic 804 may determine multiple adapted busses along different potential routes between a first and second processing component. The design logic 804 may select one of the determined adapted busses according any number of selection criteria specified in the adaptation parameters 822. Examples of selection criteria may include lowest cost, lowest power consumption, criteria related to signal driving strength, fastest latency, combinations thereof or with any additional or alternative criteria.

The design logic 804 may determine a bus specifically adapted for linking the first and second processing components, which is described in greater detail next. Determining an adapted bus may include determining any number of bus configurations such as bus width, latency, and speed, elements included in the bus such as number of bus pipeline stages and logic implementing the stages, as well as a route of the bus on a chip or IC, as just a few examples.

The design logic 804 may determine (e.g., configure) an adapted bus in any number of ways, some of which are presented next. The design logic 804 may weight various factors when determining the adapted bus, and such weights may be specified by the adaptation parameters 822. Examples of factors include area constraints for the system logic 102, cost for implementing the adapted bus, power consumption of the adapted bus, speed (e.g., bus latency) or other timing considerations, and more. The design logic 804 may determine a configuration or design for the adapted bus that meets the requirements of the adaptation parameters 822, which may include determining whether to implement a narrower, faster, and higher-power consuming bus, a wider, slower, and lower power-consuming bus, or variants in between.

The design logic 804 may identify, as an adaptation characteristic, one or more circuit characteristics and adapt the bus to include a bus adaptation based on the circuit characteristic. The design logic 804 may adapt the bus to include a bus adaptation that modifies the bus to account for the circuit characteristic, such as a circuit characteristic on a path between the first processing component and the second processing component. The circuit characteristic may be any characteristic of a circuit, die, printed circuit board, SoC, or other circuitry that is part of the circuit layout. The circuit characteristic may include, as examples, routing space, noise environment variations at different positions in the circuit layout, distance between components, PVT variations, speed variations, metal / polysilicon width or layer or molecular composition, fabrication techniques, clock tree depths, and more. The circuit characteristic may include on-chip variations that may affect the performance of the bus.

As one example, the design logic 804 may determine a variance of one or more clock characteristics, including a clock signal supplied to the bus. In some variations, the design logic 804 may determine the effect of clock tree depth at particular positions along potential routes or paths for the bus or within a predetermined area surrounding the bus (e.g., within a particular radius or zone surrounding the bus). Clock tree depth may include a degree of tree fanout, the depth of the clock tree, or any other factors that may affect the clock performance. Process, Voltage, and Temperature (PVT) variations may have a greater effect on deeper clock trees, and the design logic 804 may adapt the bus to minimize or reduce these effects. For example, the design logic 804 may widen a data width of the bus and reduce the timing constraints for propagating data through the bus, e.g., through the expander 221 and implementing subsequent bus pipeline stages according to less stringent timing closure constraints.

The design logic 804 may also identify distance between processing components as an adaptation characteristic and determine an adapted bus based on the distance between the first and second processing components linked by the adapted bus. The adaptation parameters 822 may include a distance threshold (e.g., as measured in physical distance, number of clock cycles, or according to any other measurement). The design logic 804 may determine to widen a data width for a portion of the adapted bus when the distance between the first and second processing components exceeds the distance threshold. When the distance between the first and second processing components does not exceed a distance threshold, the design logic 804 may maintain a fixed width for the adapted bus. Put another way, the system logic 704 may identify a circuit characteristic as distance between the first and second processing components. The system logic 704 may adapt the bus to include a bus adaptation in the form of a bus expander and/or narrower because of the distance.

As another example, the design logic 804 may identify, as an adaptation characteristic, a circuit characteristic or on-chip variation that occurs at a particular location in the circuit layout. In response, the design logic 804 may adapt the bus to include a bus adaption including a bus expander prior to a particular location where on-chip variation occurs. The design logic 804 may also adapt the bus to include a bus narrower positioned after the particular location of the on-chip variation.

The design logic 804 may account for data interface requirements of the first or second processing components. For example, the design logic 804 may specify a width for particular portions of the bus at matches a width (e.g., in bits) of a data interface for the first processing component, second processing component, or both. To illustrate, the design logic 804 may identify a data interface requirement for a data interface included in the first or second processing components. The design logic 804 may adapt the bus to include temporary incompatibility with the data interface requirement along the bus, e.g., widen or narrow the bus to a data width that does not meet the data interface requirement of the first or second processing components. In this case, the design logic 804 may return the bus to compatibility with the data interface prior to the bus reaching the first or second processing components, e.g., by widening or narrowing the data width of the bus to meet the respective data interface requirement(s).

The design logic 804 may also consider, as an adaptation characteristic, layout constraints when determining an adapted bus. For example, buses with a lesser number of bus pipeline stages may support greater wiring distance between the bus pipeline stages. In that regard, the design logic 804 may determine to route an adapted bus over a particular processing component instead of routing the adapted bus around the particular processing component. For instance, the processing component may be preconfigured circuit that the design logic 804 is prevented from adjusting (e.g., a licensed design). In this case, the design logic 804 may be unable to adjust portions of the preconfigured circuit to support routing the bus through the preconfigured circuit. The design logic 804 may select a bus design with a greater physical distance between bus pipeline stages, such as the buses 502, 602 or 701, to route the bus over the preconfigured circuit, e.g., routing the wiring at a higher fabrication layer in the IC because no flip-flops are other pipeline stage logic are needed in other fabrication layers used by the preconfigured circuit. In a similar sense, bus designs with similarly reduced timing constraints between bus pipeline stages may provide greater freedom in determining a routed path for the adapted bus.

The design logic 804 may select a design for an adapted bus with a reduced number of large driving buffers implemented in for faster, narrower buses meeting single cycle timing closure. In that regard, the design logic 804 may reduce the power consumption of the adapted bus.

In some variations, the design logic 804 may determine a cost for a bus based on the bus width and number of pipeline stages in a bus. One cost determination example is presented next with respect to clock skew. Clock skew (or clock uncertainty) in a particular portion of a chip may reduce the usable clock period between two pipeline stages. In other words, the greater the clock skew in a region, the stricter the timing constraint the bus may need to meet between consecutive pipeline stages of the bus. In some variations, the design logic 804 may determine the cost of a bus as the width of the bus * (number of bus pipeline stages+1). Accordingly, for a bus of width of ten (10) bits with five (5) pipeline stages, the design logic 804 may determine a cost of 10 * (5+1)=60.

For a portion of the chip that skews a clock to reduce the available clock cycle by 33%, the design logic 804 may determine that latency between pipeline stages in the bus be reduced by 33%. Accordingly, the design logic 804 may determine a reduced distance that a pipeline stage must cover, accounting for the clock skew and reduced clock availability. In this example, the design logic 804 may determine that each stage must now cover ⅕−(⅕* ⅓)= 2/15 of the distance of the between processing components to account for the clock skew. As such, the design logic 804 may determine that one implementation for an adapted bus as a bus with width of ten (10) bits and eight (8) pipeline stages. The design logic 804 may compute a score of 10* (8+1)=90 for this adapted bus.

As another possibility for an adapted bus, the design logic 804 may determine an adapted bus with an expanded data width. For example, the design logic 804 may compute the cost for an adapted bus that with a doubled bus width of twenty (20) bits. In this case, the design logic 804 may determine that a pipeline stage in this expanded bus must cover ⅕+⅕−(⅕* ⅓)= 5/15 (or ⅓) of the distance between processing components. Accordingly, the design logic 804 may determine a cost of 20 * (3+1)=80 for the adapted bus with doubled bus width. In a similar fashion, the design logic 804 may factor any number of chip-level parameters and/or adaptation characteristics in determining a cost for potential adapted buses. The design logic 804 may select the adapted bus with, for example, the lowest cost when determining an adapted bus to link a first and second processing component.

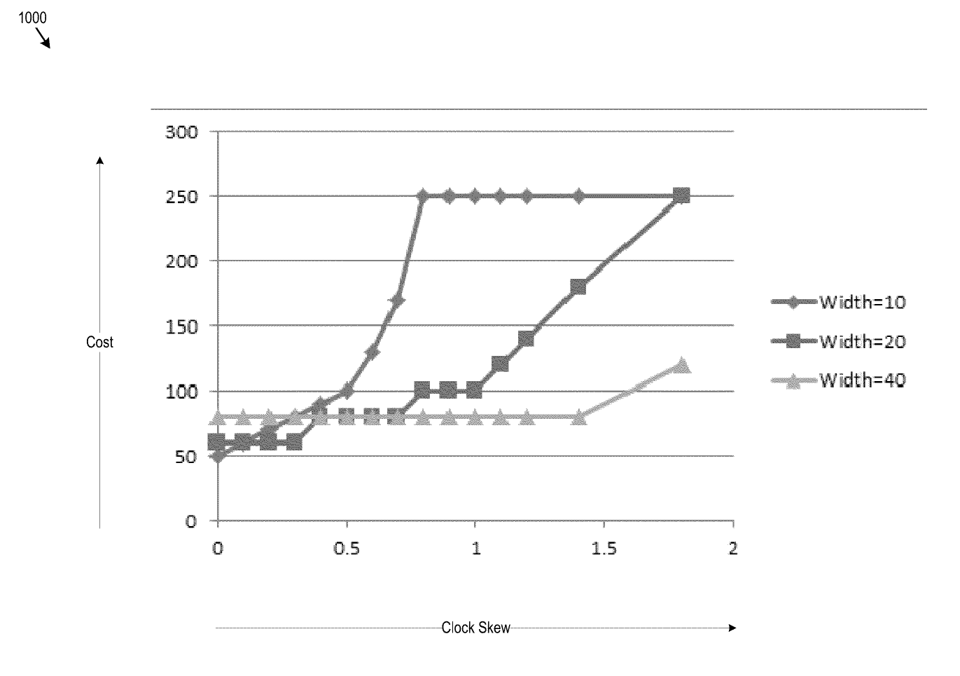

FIG. 10 shows an example of a cost graph 1000 that the design logic 804 may determine. In FIG. 10, the design logic 804 may determine the cost as the width of a bus * (number of stages+1), as shown through the y-axis of the cost graph 1000. The x-axis of the exemplary cost graph 1000 shown in FIG. 10 shows a clock skew factor ranging from 0 (0%) to 2.0 (200%). In that regard, the clock skew of chip portion may be greater than the entire clock period, and the design logic 804 may determine an adapted bus accordingly. As seen in FIG. 10, the cost graph 1000 depicts the cost for a bus of widths 10 (line with diamond indices), 20 (line with square indices), and 40 bits (line with triangle indices) for varying clock skews. The cost graph 1000 shows one exemplary cost determination the design logic 804 may employ when determining an adapted bus.

As described above, the system logic 102 may implement adapted buses, e.g., buses specifically adapted in configuration, routing, and elements present in the bus. As such, the system logic 102 may implement buses specifically adapted based on various factors, such as cost, power, area, speed, timing, effect of on-chip variations, routing constraints or options, distance information, layout constraints, and more. The system logic 102 may include multiple adapted buses, and each of the adapted buses may be respectively adapted according to the varying layout effects applicable to the adapted buses and/or any other adaptation parameters listed above.

Note that an adapted bus is not limited to a single instance of an expanded and a narrower. Instead, any adapted bus may expand and narrow at any specified locations. The locations may be specified by the adaptation parameters 822. For instance, a bus may expand to 2N wide across a portion of a chip where additional routing room for traces is available, contract back to N-wide across a crowded portion of the chip where less room is available, expand again to 2N once the crowded portion is passed, and then contract back to N-wide at the destination processing element. In other words, among other parameters, the adaptation parameters 822 may specify bus expansion when and where routing area is available to do expand, and may specify bus contraction where routing area is not sufficient for the current bus width that would otherwise run into the area.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the systems and logic described above, e.g., system logic 102, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Various implementations have been specifically described. However, many other implementations are also possible.

What is claimed is:

1. A circuit comprising:
a first processing component;
a second processing component; and
a bus between the first and second processing components, the bus comprising:
a bus adaptation that modifies the bus to account for a circuit characteristic between the first processing component and the second processing component.

2. The circuit of claim 1, where the bus adaptation comprises a bus expander.

3. The circuit of claim 1, where the bus adaption comprises a bus narrower.

4. The circuit of claim 1, where the circuit characteristic comprises an on-chip variation.

5. The circuit of claim 4, where the on-chip variation occurs at a particular location; and where:
the bus adaption comprises a bus expander prior to the particular location where the on-chip variation occurs.

6. The circuit of claim 5, where the bus adaption further comprises a bus narrower positioned after the particular location.

7. The circuit of claim 6, where the circuit further comprises a common clock tree in communication with the bus expander and the bus narrower.

8. The circuit of claim 4, where the on-chip variation occurs at a particular location; and where:
the bus adaption comprises a bus narrower prior to the particular location where the on-chip variation occurs.

9. The circuit of claim 8, where the bus adaption further comprises a bus expander positioned after the particular location.

10. The circuit of claim 1, where the circuit characteristic comprises distance between the first and second processing components.

11. The circuit of claim 1, where the circuit characteristic comprises distance between the first and second processing components; and where the bus adaptation comprises a bus expander because of the distance.

12. The circuit of claim 1, where the circuit characteristic comprises a clock tree depth of a clock signal supplied to the first or second processing component.

13. A system comprising:
a memory storing an adaption parameter; and
system logic in communication with the memory, the system logic configured to:
obtain a circuit layout that includes a first processing component and a second processing component;
determine, from the circuit layout, a circuit characteristic between the first and second processing components; and
determine a bus adaptation to a bus between the first and second processing components based on the circuit characteristic.

14. The system of claim 13, where the bus adaptation comprises a bus expander; and where the circuit characteristic comprises distance between the first and second processing components exceeding a distance threshold.

15. The system of claim 13, where the first processing component comprises a data interface with a data interface requirement; and
where the bus adaptation comprises a temporary incompatibility with the data interface requirement along the bus.

16. The system of claim 15, where the bus adaptation is configured to also return the bus to compatibility with the data interface prior to reaching the first processing component.

17. A method comprising:
in a design system:
identifying a bus in a circuit layout;
identifying an on-chip variation in the circuit layout that affects the performance of the bus in the circuit layout; and
adapting the bus in the circuit layout to account for the on-chip variation.

18. The method of claim 17, where adapting the bus comprises adjusting a data width of the bus to account for the on-chip variation.

19. The method of claim 18, where adjusting the data width of the bus comprises widening the data width into a widened data width for a portion of the bus.

20. The method of claim 17, comprising adapting the bus in the circuit layout without adjusting a clock signal supplied to the bus.
